(19) United States
(12) Patent Application Publication
(10) Pub. No.: US 2004/0044060 A1
(43) Pub. Date: Mar. 4, 2004

(54) Fungicidal mixture

(76) Inventors: Bernd Muller, Frankenthal (DE); Arne Ptock, Ludwigshafen (DE); Eberhard Ammermann, Heppenheim (DE); Reinhard Stierl, Mutterstadt (DE); Gisela Lorenz, Hambach Hambach (DE); Siegfried Strathmann, Limburgerhof (DE); Maria Scherer, Landau (DE); Klaus Schelberger, Gonnheim (DE); Joachim Leyendecker, Hassloch (DE); Manfred Hampel, Neustadt (DE)

Correspondence Address: KEIL & WEINKAUF, 1350 CONNECTICUT AVENUE, N.W., WASHINGTON, DC, 20036, US

(21) Appl. No.: 10/250,564

(22) PCT Filed: Jan. 12, 2002
(86) PCT No.: PCT/EP02/00235

(30) Foreign Application Priority Data
Jan. 16, 2001 (DE) 101 01 924.6

(51) Int. Cl. A01N 43/50; A01N 43/56

(52) U.S. Cl. 514/398; 514/406

(57) ABSTRACT

Fungicidal mixtures, comprising

A) imidazole derivatives of the formula I

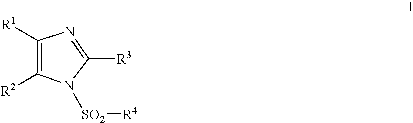

in which R¹ and R² are halogen or phenyl which may be substituted by halogen or alkyl or R¹ and R² together with the bridging C═C double bond form a 3,4-difluoromethylenedioxyphenyl group; R³ is cyano or halogen, and R⁴ is dialkylamino or isoxazol-4-yl which may carry two alkyl radicals; and

B) carbamates of the formula II,

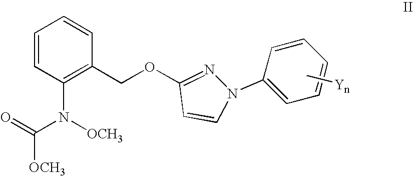

in which n is 1 or 2 and Y is halogen, alkyl or haloalkyl, where the radicals Y may be different if n is 2; and

C) amide compounds of the formula III

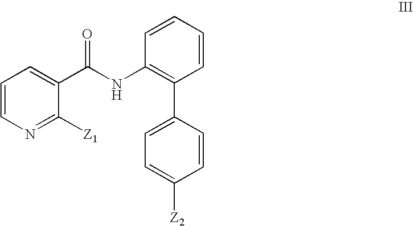

in which Z¹ and Z² are identical or different and are haloge nitro, cyano, alkyl, alkenyl, alkynyl, haloalkyl, haloalkenyl, haloalkynyl, alkoxy, haloalkoxy, haloalkylthio alkylsulfinyl or alkylsulfonyl; in a synergistically effective amount, methods for controlling harmful fungi using mixtures of the compounds I, II and III and the use of the compounds I, II and III for preparing such mixtures are described.

The present invention relates to fungicidal mixtures, comprising

A) imidazole derivatives of the formula I

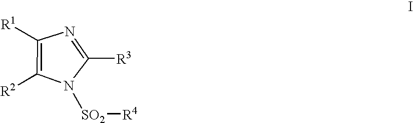

in which R¹ and R² are halogen or phenyl which may be substituted by halogen or C₁-C₄-alkyl or

R¹ and R² together with the bridging C═C double bond form a 3,4-difluoromethylenedioxyphenyl group;

R³ is cyano or halogen, and

R⁴ is di(C₁-C₄-alkyl)amino or isoxazol-4-yl which may carry two C₁-C₄-alkyl radicals; and

B) carbamates of the formula II,

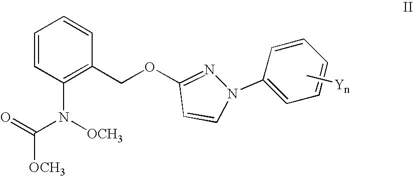

in which n is 1 or 2 and Y is halogen, C₁-C₄-alkyl or C₁-C₂-haloalkyl, where the radicals Y may be different if n is 2; and

C) amide compounds of the formula III

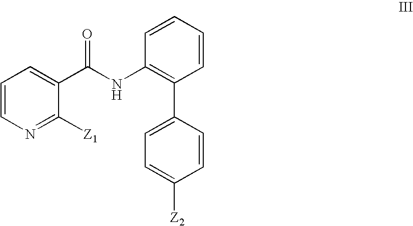

in which Z¹ and Z² are identical or different and are halogen, nitro, cyano, C₁-C₈-alkyl, C₂-C₈-alkenyl, C₂-C₈-alkynyl, C₁-C₈-haloalkyl, C₂-C₈-haloalkenyl, C₂-C₈-haloalkynyl, C₁-C₈-alkoxy, C₁-C₈-haloalkoxy, C₁-C₈-haloalkylthio, C₁-C₈-alkylsulfinyl or C₁-C₈-alkylsulfonyl;

in a synergistically effective amount.

The invention also relates to methods for controlling harmful fungi using mixtures of the compounds I, II and III, and to the use of the compounds I, II and III for preparing such mixtures.

The imidazole derivatives of the formula I, their preparation and their action against harmful fungi are known from the literature (EP-A 298 196, WO-A 97/06171).

Also known from the literature are the carbamates of the formula II, their preparation and their action against harmful fungi (WO-A 93/15046; WO-A 96/01256 and WO-A 96/01258).

The compounds of the formula III, their preparation and their action against harmful fungi are likewise known from the literature (EP-A 545 099).

It is an object of the present invention to provide mixtures which have an improved activity against harmful fungi combined with a reduced total amount of active compounds applied (synergistic mixtures), with a view to reducing the application rates and improving the activity spectrum of the known compounds I, II and III.

We have found that this object is achieved by the mixture defined at the outset. Moreover, we have found that applying the compounds I, II and III simultaneously, i.e. either jointly or separately, or applying the compounds I, II and III successively provides better control of harmful fungi than is possible with the individual compounds alone.

The formula I represents in particular imidazole derivatives of the formula I in which R¹ is halogen, in particular chlorine, and R² is tolyl, in particular p-tolyl.

Preference is also given to compounds of the formula I in which R⁴ is dimethylamino.

In addition, particular preference is given to the compound of the formula Ia (common name: cyazofamid). This compound is known from EP-A 298 196.

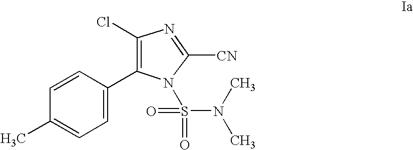

Preference is furthermore given to compounds of the formula I in which R¹ and R² together with the bridging C═C double bond form a 3,4-difluoromethylenedioxyphenyl group.

In addition, preference is given to compounds of the formula I in which R⁴ is 3,5-dimethylisoxazol-4-yl.

Particular preference is given to the compounds of the formula Ib in which X is halogen.

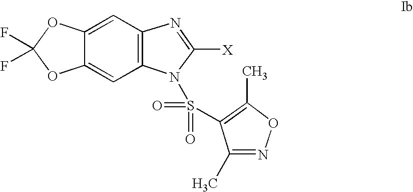

Halogen denotes fluorine, chlorine, bromine and iodine. Particular preference is given to compounds of the formula Ib in which X is bromine (Ib.1) or chlorine (Ib.2).

The formula II represents in particular carbamates in which the combination of the substituents corresponds to one row of the table below:

| | |
|---|---|
| | II |
| 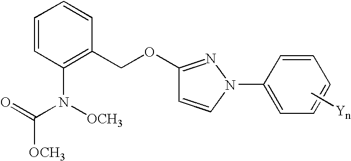 | |

| No. | Yₙ |
|---|---|
| II-1 | 2-F |
| II-2 | 3-F |
| II-3 | 4-F |
| II-4 | 2-Cl |
| II-5 | 3-Cl |
| II-6 | 4-Cl |
| II-7 | 2-Br |
| II-8 | 3-Br |
| II-9 | 4-Br |
| II-10 | 2-CH₃ |
| II-11 | 3-CH₃ |
| II-12 | 4-CH₃ |
| II-13 | 2-CF₃ |
| II-14 | 3-CF₃ |
| II-15 | 4-CF₃ |
| II-16 | 2,4-F₂ |
| II-17 | 2,4-Cl₂ |
| II-18 | 3,4-Cl₂ |
| II-19 | 2-Cl, 4-CH₃ |
| II-20 | 3-Cl, 4-CH₃ |

Particular preference is given to compounds of the formula II in which Y is located in the para position; these compounds are described by the formula IIa:

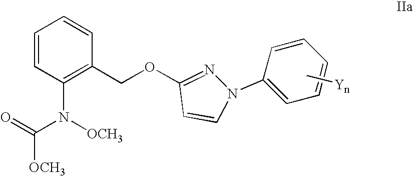

Particular preference is also given to compounds of the formula II in which Y is fluorine, chlorine, methyl or trifluoromethyl. Especially preferred are the compounds II-3, II-6, II-12 and II-17, in particular the compound. II-6.

Among the compounds of the formula III, particular preference is given to those in which the combination of the substituents corresponds to one row of the table below:

| No. | Z¹ | Z² |
|---|---|---|
| III-1 | F | F |
| III-2 | F | Cl |
| III-3 | F | Br |
| III-4 | Cl | F |
| III-5 | Cl | Cl |
| III-6 | Cl | Br |
| III-7 | CF₃ | F |
| III-8 | CF₃ | Cl |
| III-9 | CF₃ | Br |
| III-10 | CF₂H | F |
| III-11 | CF₂H | Cl |
| III-12 | CF₂H | Br |
| III-13 | CH₃ | F |
| III-14 | CH₃ | Cl |
| III-15 | CH₃ | Br |
| III-16 | OCH₃ | F |
| III-17 | OCH₃ | Cl |
| III-18 | OCH₃ | Br |
| III-19 | SCH₃ | F |
| III-20 | SCH₃ | Cl |
| III-21 | SCH₃ | Br |
| III-22 | S(O)CH₃ | F |
| III-23 | S(O)CH₃ | Cl |
| III-24 | S(O)CH₃ | Br |
| III-25 | SO₂CH₃ | F |
| III-26 | SO₂CH₃ | Cl |
| III-27 | SO₂CH₃ | Br |

Particular preference is given to the compounds III in which Z¹ is CF₃ or halogen and Z² is halogen.

Especially preferred is the mixture of the compounds Ia, II-6 and III-5.

Owing to the basic character of their nitrogen atoms, the compounds I, II and III are capable of forming salts or adducts with inorganic or organic acids or with metal ions.

Examples of inorganic acids are hydrohalic acids such as hydrofluoric acid, hydrochloric acid, hydrobromic acid and hydriodic acid, carbonic acid, sulfuric acid, phosphoric acid and nitric acid.

Suitable organic acids are, for example, formic acid and alkanoic acids, such as acetic acid, trifluoroacetic acid, trichloroacetic acid and propionic acid, and also glycolic acid, lactic acid, succinic acid, citric acid, benzoic acid, cinnamic acid, oxalic acid, p-toluenesulfonic acid, salicylic acid, p-aminosalicylic acid, 2-phenoxybenzoic acid and 2-acetoxybenzoic acid.

Suitable metal ions are, in particular, the ions of the elements chromium, manganese, iron, cobalt, nickel, copper, zinc, calcium, magnesium, aluminum, tin and lead. If appropriate, the metals can exist in the various valences which they can assume.

When preparing the mixtures, it is preferred to employ the pure active compounds I, II and III, to which further active compounds against harmful fungi or other pests, such as insects, arachnids or nematodes, or else herbicidal or growth-regulating active compounds or fertilizers can be admixed.

The mixtures of the compounds I, II and III, or the compounds I, II and III used simultaneously, jointly or separately, exhibit outstanding activity against a wide range of phytopathogenic fungi, in particular from the classes of the Ascomycetes, Basidiomycetes, Phycomycetes and Deuteromycetes. Some of them act systemically and can therefore also be employed as foliar- and soil-acting fungicides.

They are especially important for controlling a large number of fungi in a variety of crop plants, such as cotton, vegetable species (e.g. cucumbers, beans, tomatoes, potatoes and cucurbits), barley, grass, oats, bananas, coffee, maize, fruit species, rice, rye, soya, grapevine, wheat, ornamentals, sugar cane, and a variety of seeds.

They are particularly suitable for controlling the following phytopathogenic fungi: Erysiphe graminis (powdery mildew) in cereals, Erysiphe cichoracearum and Sphaerotheca fuliginea in cucurbits, Podosphaera leucotricha in apples, Uncinula necator in grapevines, Puccinia species in cereals, Rhizoctonia species in cotton, rice and lawns, Ustilago species in cereals and sugar cane, Venturia inaequalis (scab) in apples, Helminthosporium species in cereals, Septoria nodorum in wheat, Botrytis cinera (gray mold) in strawberries, vegetables, ornamentals and grapevines, Cercospora arachidicola in groundnuts, Pseudocercosporella herpotrichoides in wheat and barley, Pyricularia oryzae in rice, Phytophthora infestans in potatoes and tomatoes, Plasmopara viticola in grapevines, Pseudoperonospora species in hops and cucumbers, Alternaria species in vegetables and fruit, Mycosphaerella species in bananas and Fusarium and Verticillium species.

They can furthermore be employed in the protection of materials (for example the protection of wood), for example against Paecilomyces variotii.

The compounds I, II and III can be applied simultaneously, i.e. either jointly or separately, or successively, the sequence, in the case of separate application, generally not having any effect on the result of the control measures.

The compounds I, II and III are usually employed in a weight ratio of (I:II and I:III) in each case from 20:1 to 1:20, in particular 10:1 to 1:10, preferably from 5:1 to 1:5.

Depending on the kind of effect desired, the application rates of the mixtures according to the invention are, in particular in agricultural crop areas, from 0.01 to 8 kg/ha, preferably 0.1 to 5 kg/ha, in particular 0.1 to 3.0 kg/ha.

The application rates of the compounds I are from 0.01 to 1 kg/ha, preferably 0.05 to 0.5 kg/ha, in particular 0.05 to 0.3 kg/ha.

Correspondingly, in the case of the compounds II and III, the application rates are from 0.01 to 1 kg/ha, preferably 0.02 to 0.5 kg/ha, in particular 0.05 to 0.3 kg/ha.

For seed treatment, the application rates of the mixture are generally from 0.001 to 250 g/kg of seed, preferably 0.01 to 100 g/kg, in particular 0.01 to 50 g/kg.

If phytopathogenic harmful fungi are to be controlled, the separate or joint application of the compounds I, II and III or of the mixtures of the compounds I, II and I!I is effected by spraying or dusting the seeds, the plants-or the soils before or after sowing of the plants, or before or after plant emergence.

The fungicidal synergistic mixtures according to the invention or the compounds I, II and III can be formulated for example in the form of ready-to-spray solutions, powder and suspensions or in the form of highly concentrated aqueous, oily or other suspensions, dispersions, emulsions, oil dispersions, pastes, dusts, materials for broadcasting or granules, and applied by spraying, atomizing, dusting, broadcasting or watering. The use form depends on the intended purpose; in any case, it should ensure as fine and uniform as possible a distribution of the mixture according to the invention.

The formulations are prepared in a known manner, e.g. by adding solvents and/or carriers. The formulations are usually admixed with inert additives, such as emulsifiers or dispersants.

Suitable surfactants are the alkali metal salts, alkaline earth metal salts and ammonium salts of aromatic sulfonic acids, e.g. ligno-, phenol-, naphthalene- and dibutylnaphthalenesulfonic acid, and of fatty acids, alkyl- and alkylarylsulfonates, alkyl sulfates, lauryl ether sulfates and fatty alcohol sulfates, and salts of sulfated hexa-, hepta- and octadecanols, or of fatty alcohol glycol ethers, condensates of sulfonated naphthalene and its derivatives with formaldehyde, condensates of naphthalene or of the naphthalenesulfonic acids with phenol and formaldehyde, polyoxyethylene octylphenol ether, ethoxylated isooctyl-, octyl- or nonylphenol, alkylphenol or tributylphenyl polyglycol ethers, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignosulfite waste liquors or methylcellulose.

Powders, materials for broadcasting and dusts can be prepared by mixing or jointly grinding the compounds I, II or III or the mixture of the compounds I, II and III with a solid carrier.

Granules (e.g. coated granules, impregnated granules or homogeneous granules) are usually prepared by binding the active compound, or active compounds, to a solid carrier.

Fillers or solid carriers are, for example, mineral earths, such as silicas, silica gels, silicates, talc, kaolin, limestone, lime, chalk, bole, loess, clay, dolomite, diatomaceous earth, calcium sulfate, magnesium sulfate, magnesium oxide, ground synthetic materials and fertilizers, such as ammonium sulfate, ammonium phosphate, ammonium nitrate, ureas, and products of vegetable origin, such as cereal meal, tree bark meal, wood meal and nutshell meal, cellulose powders or other solid carriers.

The formulations generally comprise from 0.1 to 95% by weight, preferably 0.5 to 90% by weight, of one of the compounds I, II or III or the mixture of the compounds I, II and III. The active compounds are employed in a purity of from 90% to 100%, preferably 95% to 100% (according to NMR spectrum or HPLC).

The compounds I, II and III, the mixtures, or the corresponding formulations, are applied by treating the harmful fungi, their habitat, or the plants, seeds, soils, areas, materials or spaces to be kept free from them with a fungicidally effective amount of the mixture, or of the compounds I, II and III in the case of separate application.

Application can be effected before or after infection by the harmful fungi.

### USE EXAMPLE

The synergistic activity of the mixtures according to the invention can be demonstrated by the following experiments:

The active compounds, separately or jointly, were formulated as a 10% emulsion in a mixture of 63% by weight of cyclohexanone and 27% by weight of emulsifier, and diluted with water to the desired concentration.

Evaluation was carried out by determining the infected leaf areas in percent. These percentages were converted into efficacies. The efficacy (W) was calculated as follows using Abbot's formula:

W=(1−α)-100/P

α corresponds to the fungal infection of the treated plants in % and

β corresponds to the fungal infection of the untreated (control) plants in %

An efficacy of 0 means that the infection level of the treated plants corresponds to that of the untreated control plants; an efficacy of 100 means that the treated plants were not infected.

The expected efficacies of the mixtures of the active compounds were determined using Colby's formula [R. S. Colby, Weeds 15, 20-22 (1967)] and compared with the observed efficacies.

E=x+y−x·y/100 Colby's formula:

E expected efficacy, expressed in % of the untreated control, when using the mixture of the active compounds A and B at the concentrations a and b

x efficacy, expressed in % of the untreated control, when using active compound A at a concentration of a

y efficacy, expressed in % of the untreated control, when using active compound B at a concentration of b.

### USE EXAMPLE

### Protective Activity Against peronospora vines Caused by Plasmopara viticola

Leaves of potted vines of the cultivar “Müller-Thurgau” were sprayed to runoff point with an aqueous preparation of active compound which had been prepared from a stock solution comprising 10% of active compound, 85% of cyclohexanone and 5% of emulsifier. The next day, the undersides of the leaves were inoculated with an aqueous zoospore suspension of Plasmopara viticola. The vines were then initially placed in a water-vapor-saturated chamber at 24° C. for 48 hours and then in a greenhouse at 20-30° C. for 5 days. After this period of time, the plants were again placed in a moist chamber for 16 hours to promote sporangiophore eruption. The extent to which the infection had developed on the undersides of the leaves was then determined visually.

TABLE A
Individual active compounds

| | | Concentration of | |
|---|---|---|---|
| | | active compound | Efficacy in % of |
| | | in the spray | the untreated |
| Example | Active compound | liquor [ppm] | control |
| 1 | control | (75% infection) | 0 |
| | (untreated) | | |
| 2 | Ia | 0.2 | 87 |
| | | 0.1 | 73 |
| | | 0.05 | 47 |
| 3 | Ib.1 | 0.2 | 80 |
| | | 0.1 | 67 |
| | | 0.05 | 47 |
| 4 | II-6 | 0.2 | 73 |
| | | 0.1 | 47 |
| | | 0.05 | 20 |
| 5 | II-12 | 0.2 | 80 |
| | | 0.1 | 73 |
| | | 0.05 | 47 |
| 6 | III-5 | 0.2 | 20 |
| | | 0.1 | 7 |
| | | 0.05 | 7 |

TABLE B
Combinations according to the invention

| | Active compound | | |
|---|---|---|---|
| | mixture | | |
| | concentration mixing | Observed | Calculated |
| Example | ratio | efficacy | efficacy*) |
| 7 | Ia + II-6 | 100 | 86 |
| | 0.1 + 0.1 ppm | | |
| | 1:1 | | |
| 8 | Ia + II-6 | 100 | 58 |
| | 0.05 + 0.05 ppm | | |
| | 1:1 | | |
| 9 | Ia + II-6 | 100 | 79 |
| | 0.1 + 0.05 ppm | | |
| | 2:1 | | |
| 10 | Ia + II-6 | 100 | 89 |
| | 0.2 + 0.05 ppm | | |
| | 4:1 | | |
| 11 | Ia + II-6 | 100 | 72 |
| | 0.05 + 0.1 ppm | | |
| | 1:2 | | |
| 12 | Ia + II-6 | 100 | 86 |
| | 0.05 + 0.2 ppm | | |
| | 1:4 | | |
| 13 | Ia + II-12 | 100 | 72 |
| | 0.05 + 0.05 ppm | | |
| | 1:1 | | |
| 14 | Ia + II-12 | 100 | 86 |
| | 0.1 + 0.05 ppm | | |
| | 2:1 | | |
| 15 | Ia + II-12 | 100 | 86 |
| | 0.05 + 0.1 ppm | | |
| | 1:2 | | |
| 16 | Ia + II-12 | 100 | 89 |
| | 0.05 + 0.2 ppm | | |
| | 1:4 | | |
| 17 | Ia + III-5 | 100 | 75 |
| | 0.1 + 0.1 ppm | | |
| | 1:1 | | |
| 18 | Ia + III-5 | 100 | 50 |
| | 0.05 + 0.05 ppm | | |
| | 1:1 | | |
| 19 | Ia + III-5 | 100 | 88 |
| | 0.2 + 0.1 ppm | | |
| | 2:1 | | |
| 20 | Ia + III-5 | 100 | 75 |
| | 0.1 + 0.05 ppm | | |
| | 2:1 | | |
| 21 | Ia + III-5 | 100 | 88 |
| | 0.2 + 0.05 ppm | | |
| | 4:1 | | |
| 22 | Ia + III-5 | 100 | 58 |
| | 0.05 + 0.2 ppm | | |
| | 1:4 | | |
| 23 | Ib.1 + II-6 | 100 | 82 |
| | 0.1 + 0.1 ppm | | |
| | 1:1 | | |
| 24 | Ib.1 + II-6 | 99 | 58 |
| | 0.05 + 0.05 ppm | | |
| | 1:1 | | |
| 25 | Ib:1 + II-6 | 100 | 89 |
| | 0.2 + 0.1 ppm | | |
| | 2:1 | | |
| 26 | Ib.1 + II-6 | 100 | 73 |
| | 0.1 + 0.05 ppm | | |
| | 2:1 | | |
| 27 | Ib.1 + II-6 | 100 | 84 |
| | 0.2 + 0.05 ppm | | |
| | 4:1 | | |
| 28 | Ib.1 + II-6 | 99 | 86 |
| | 0.05 + 0.2 ppm | | |
| | 1:4 | | |
| 29 | Ib.1 + II-12 | 100 | 72 |
| | 0.05 + 0.05 ppm | | |
| | 1:1 | | |
| 30 | Ib.1 + II-12 | 100 | 82 |
| | 0.1 + 0.05 ppm | | |
| | 2:1 | | |
| 31 | Ib.1 + II-12 | 100 | 89 |
| | 0.2 + 0.05 ppm | | |
| | 4:1 | | |
| 32 | Ib.1 + II-12 | 100 | 89 |
| | 0.05 + 0.2 ppm | | |
| | 1:4 | | |
| 33 | Ib.1 + III-5 | 87 | 73 |
| | 0.1 + 0.1 ppm | | |
| | 1:1 | | |
| 34 | Ib.1 + III-5 | 65 | 50 |
| | 0.05 + 0.05 ppm | | |
| | 1:1 | | |
| 35 | Ib.1 + III-5 | 80 | 69 |
| | 0.1 + 0.05 ppm | | |
| | 2:1 | | |
| 36 | Ib.1 + III-5 | 100 | 73 |
| | 0.1 + 0.2 ppm | | |
| | 1:2 | | |
| 37 | Ib.1 + III-5 | 80 | 57 |
| | 0.05 +0.1 ppm | | |
| | 1:2 | | |

*)calculated using Colby's formula

The test results show that for all mixing ratios the observed efficacy is higher than the efficacy calculated beforehand using Colby's formula.

We claim:

1. A fungicidal mixture, comprising
A) imidazole derivatives of the formula I 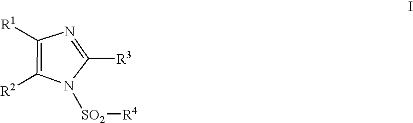
in which R¹ and R² are halogen or phenyl which may be substituted by halogen or C₁-C₄-alkyl or R¹ and R² together with the bridging C═C double bond form a 3,4-difluoromethylenedioxyphenyl group;
R³ is cyano or halogen, and
R⁴ is di(C₁-C₄-alkyl)amino or isoxazol-4-yl which may carry two C₁-C₄-alkyl radicals; and
B) carbamates of the formula II, 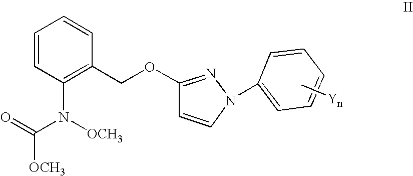
in which n is 1 or 2 and Y is halogen, C₁-C₄-alkyl or C₁-C₂-haloalkyl, where the radicals Y may be different if n is 2; and
C) amide compounds of the formula III 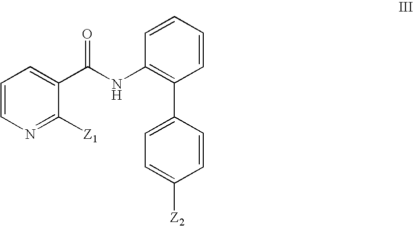
in which Z¹ and Z² are identical or different and are halogen, nitro, cyano, C₁-C₈-alkyl, C₂-C₈-alkenyl, C₂-C₈-alkynyl, C₁-C₈-haloalkyl, C₂-C₈-haloalkenyl, C₂-C₈-haloalkynyl, C₁-C₈-alkoxy, C₁-C₈-haloalkoxy, C₁-C₈-haloalkylthio, C₁-C₈-alkylsulfinyl or C₁-C₈-alkylsulfonyl;
in a synergistically effective amount.

2. A fungicidal mixture as claimed in claim 1 where the imidazole derivative I corresponds to the formula Ia.

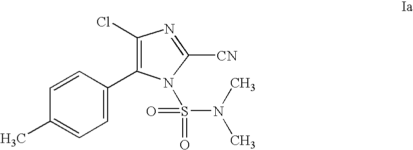

3. A fungicidal mixture as claimed in claim 1 where the imidazole derivative I corresponds to the formula Ib 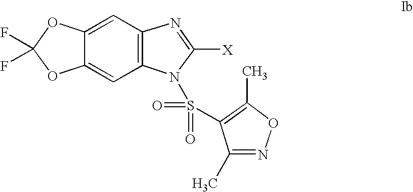
where X is chlorine or bromine.

4. A fungicidal mixture as claimed in claim 1, wherein the weight ratio of the compounds I:II and I:III is in each case from 20:1 to 1:20.

5. A method for controlling harmful fungi, which comprises treating the harmful fungi, their habitat, or the plants, seeds, soils, areas, materials or spaces to be kept free from them with imidazole derivatives of the formula I as set forth in claim 1, carbamates of the formula II as set forth in claim 1 and amide compounds of the formula III as set forth in claim 1.

6. A method as claimed in claim 5, wherein imidazole derivatives of the formula I as set forth in claim 1, carbamates of the formula II as set forth in claim 1 and amide compounds of the formula III as set forth in claim 1 are applied simultaneously, i.e. either jointly or separately, or successively.

7. A method as claimed in claim 5 or 6, wherein the imidazole derivatives of the formula I as set forth in claim 1 are applied in an amount of from 0.01 to 2.5 kg/ha.

8. A method as claimed in any of claims 5 to 7, wherein the carbamates of the formula II as set forth in claim 1 are applied in an amount of from 0.01 to 10 kg/ha.

9. A method as claimed in any of claims 5 to 8, wherein the amide compounds of the formula III as set forth in claim 1 are applied in an amount of from 0.01 to 10 kg/ha.

10. A fungicidal composition which is conditioned in three parts, one part comprising imidazole derivatives of the formula I as set forth in claim 1 in a solid or liquid carrier, the second part comprising carbamates of the formula II as set, forth in claim 1 in a solid or liquid carrier and the third part comprising amide compounds of the formula III as set forth in claim 1 in a solid or liquid carrier.
